(19) United States
(12) Patent Application Publication
(10) Pub. No.: US 2012/0011244 A1
(43) Pub. Date: Jan. 12, 2012

(54) METHOD FOR REDISTRIBUTING LICENSE TOKENS FOR A SERVICE ACROSS A CLOUD COMPUTING ENVIRONMENT

(75) Inventor: Zhongwen Zhu, Saint-Laurent (CA)

(73) Assignee: TELEFONAKTIEBOLAGET L M ERICSSON (PUBL), Stockholm (SE)

(21) Appl. No.: 12/833,448

(22) Filed: Jul. 9, 2010

(51) Int. Cl. G06F 15/173

(52) U.S. Cl. 709/224; 709/223

(57) ABSTRACT

The invention relates to a method for redistributing license tokens for a service to license servers across a cloud computing environment. The method comprises the steps of acquiring current license tokens information of the license servers for the service, detecting a need for redistribution of the license tokens to the license servers and redistributing the license tokens to the license servers across the cloud computing environment according to the need for redistribution and according to the current license tokens information of the license servers for the service.

### TECHNICAL FIELD

The present invention relates to license management for a service in the context of a cloud computing environment.

### BACKGROUND

FIG. 1 shows a license client-server architecture that can do license control for traffic capacity. In such architecture, the client side application 20 of the license component is deployed in multiple traffic processors (TPs) 25 while the server side application 30 of the license component is deployed in one license server 35, which can be a server instance. If the license server is required to be High Availability (HA), two license servers are deployed, and the configuration is made accordingly.

The traffic processors 25 are used to handle traffic requests towards deployed services. Normally under one physical node, there are several TPs 25 that are able to handle a large volume of service traffic at the same time. A Virtual Internet Protocol (VIP) router 40 can be configured to route the incoming service requests to different TPs 25 based upon specified routing criteria, or for instance, according to a simple round-robin scheme or according to other rules for handling the traffic load.

An existing method to control the usage of the deployed services under a license is illustrated in FIG. 1. Normally it can be described in two separate flows at high level, which are described hereafter. Firstly, a flow to cache the capacity license information in a local TP is described, it has basically four steps. In step a, the client side application 20 of the license component sends a “license request” to the server side application 30 of the license component. In step b, the server side application 30 retrieves license key information from a license key file 32, and then retrieves a hardware fingerprint or hardware identifier (ID) required for this licensed feature. The server side application 30 verifies the hardware identifier 34 of the hardware it is running on. In step c, the hardware returns its hardware ID 34 to the server side application 30 of the license component. In step d, after successful verification of the hardware ID 34 in relation with the licensed feature, the license server 35 sends the license key information to the requestor TP. Then the license key information is cached locally in the TP for handling the incoming service requests.

Secondly, a flow to verify the capacity license is described, it has five steps, still illustrated in FIG. 1. In step 1, a service request arrives at the VIP router 40. In step 2, based upon the specified routing criteria, the request is sent to one of the TPs. In step 3, the client side application 20 (which can also be called service application) uses the license component to check the licensed capacity for handling the service request. This step can be done before processing the received service request. In order to check the license capacity, the client side application gets, preferably before the service request is handled, the license key information from the license server according to the previous flow. In step 4, after passing the license verification successfully, i.e. the licensed capacity for handling the service is available, a special instance is established to handle the incoming request by sending out a response or by forwarding the request. In step 5, the response is sent or the request is forwarded.

Nowadays, the trends to separate software from hardware are adopted not only by Information Technology (IT) industries but also in the telecom world. Thus, cloud computing and virtual environment are foreseen as being part of the future of telecommunication services. Cloud computing is generally defined as a computing capability that provides an abstraction between the computing resource and its underlying physical architecture (e.g., servers, storage, networks), enabling convenient, on-demand network access to a shared pool of configurable computing resources that can be rapidly provisioned and released with minimal management effort or service provider interaction.

Therefore the traditional way to bind the software to the hardware using license key information in combination with hardware ID, as shown in FIG. 1 is not applicable to a cloud computing environment.

### SUMMARY

It is therefore an object of this invention to provide a method, a license pool server instance and a license server for overcoming at least some of the prior art drawbacks.

Accordingly, there is provided a method for redistributing license tokens for a service to license servers across a cloud computing environment. The method comprises the steps of acquiring current license tokens information of the license servers for the service, detecting a need for redistribution of the license tokens to the license servers and redistributing the license tokens to the license servers across the cloud computing environment according to the need for redistribution and according to the current license tokens information of the license servers for the service.

There is also provided a method for distributing a license key for a service from a license server to a client in a cloud computing environment. The method comprises the step of receiving a request for a license key for a service, from the client, at the license server, the request comprising a service identifier. The method also comprises the steps of detecting, in a local cache of the license server, that no license token is available for the service and sending a request for an additional license token for the service to a license pool server instance. The method comprises the steps of receiving the additional license token for the service from the license pool server instance, generating a license key based on the service identifier of the service, using an available license token and sending the license key to the client.

There is provided a license pool server instance for redistributing license tokens for a service to license servers across a cloud computing environment. The license pool server instance comprises a processing module for acquiring current license tokens information of the license servers for the service, for detecting a need for redistribution of the license tokens in the license servers and for redistributing license tokens to the license servers across the cloud computing environment according to the need for redistribution and according to the current license tokens information of the license servers for the service.

There is also provided a license server for distributing a license key for a service to a client in a cloud computing environment. The license server comprises a communication interface for receiving a request for a license key for a service, from the client, the request comprising a service identifier. The license server comprises an interface to a local cache for detecting if the license server has an available license token for the service. The communication interface is further for sending a request for an additional license tokens for the service to a license pool server instance and for receiving the additional license token for the service from the license pool server instance. The license server comprises a processing module for generating a license key based on the service identifier of the service, using an available license token. The communication interface is further for sending the license key to the client.

### BRIEF DESCRIPTION OF THE DRAWINGS

The objects and advantages of the invention will be understood by reading the detailed description in conjunction with the figures, wherein:

FIG. 1 is a block diagram illustrating a license client-server architecture of the prior art;

FIG. 2 is a block diagram illustrating a cloud computing environment where a service is deployed in three different locations;

FIG. 3 is a block diagram illustrating license pool server instance for redistributing license tokens for a service to license servers across a cloud computing environment according to an exemplary embodiment of the invention;

FIG. 4 is a flowchart of a method for redistributing license tokens for a service to license servers across a cloud computing environment according to the invention;

FIG. 5 is a flowchart of a method for distributing a license key for a service from a license server to a client in a cloud computing environment according to the invention;

FIG. 6 is a flowchart of yet another method for redistributing license tokens according to the invention;

FIG. 7 is a block diagram of a license pool server instance according to the invention;

FIG. 8 is a block diagram of a license server according to the invention; and

FIG. 9 is a flow diagram of an exemplary embodiment of a method according to the invention.

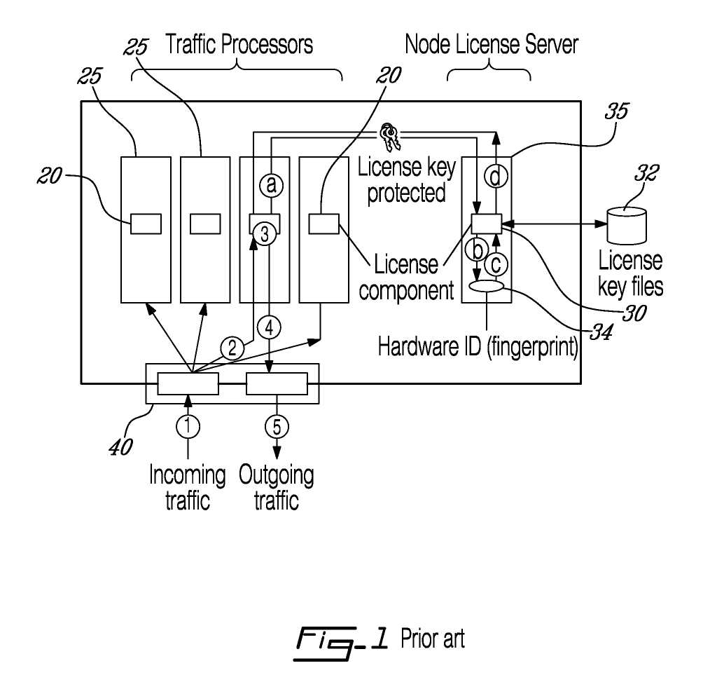

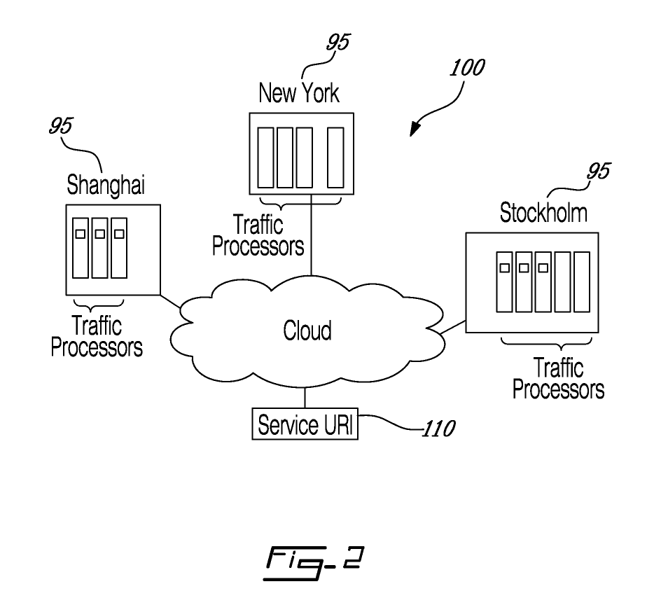

### DETAILED DESCRIPTION

The various features of the invention will now be described with reference to the figures. These various aspects are described hereafter in greater detail in connection with exemplary embodiments to facilitate an understanding of the invention, but should not be construed as limited to these embodiments. Rather, these embodiments are provided so that the disclosure will be thorough and complete, and will fully convey the scope of the invention to those skilled in the art.

The embodiments according to the present invention are described with reference to block diagrams and/or operational illustrations of methods, servers, and computer program products. It is to be understood that each block of the block diagrams and/or operational illustrations, and combinations of blocks in the block diagrams and/or operational illustrations, can be implemented by radio frequency, analog and/or digital hardware, and/or computer program instructions. These computer program instructions may be provided to a processor circuit of a general purpose computer, special purpose computer, ASIC, and/or other programmable data processing apparatus, such that the instructions, which execute via the processor of the computer and/or other programmable data processing apparatus, create means for implementing the functions/acts specified in the block diagrams and/or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Furthermore, in some illustrations, some blocks may be optional and may or may not be executed; these are generally illustrated with dashed lines.

FIG. 2 illustrates a cloud computing environment 100, where the same service is deployed in three different locations 95, e.g. Shanghai, New York and Stockholm. The service is accessible to clients via a service identifier or a service Uniform Resource Identifier (URI) 110 through the cloud computing environment 100. Therefore, a client, which can also be called license client, or a user, of the service is not bound to a physical location 95 or to a physical device anymore, as licenses for the service are bound to identifier or service URI 110 of the service. The client can thus be located anywhere to access the service through the cloud computing environment 100.

Furthermore, in such a dynamic environment, the service can be dynamically shifted from one location 95 to a new location, e.g. to Montreal, or to a plurality of other locations, without service interruption.

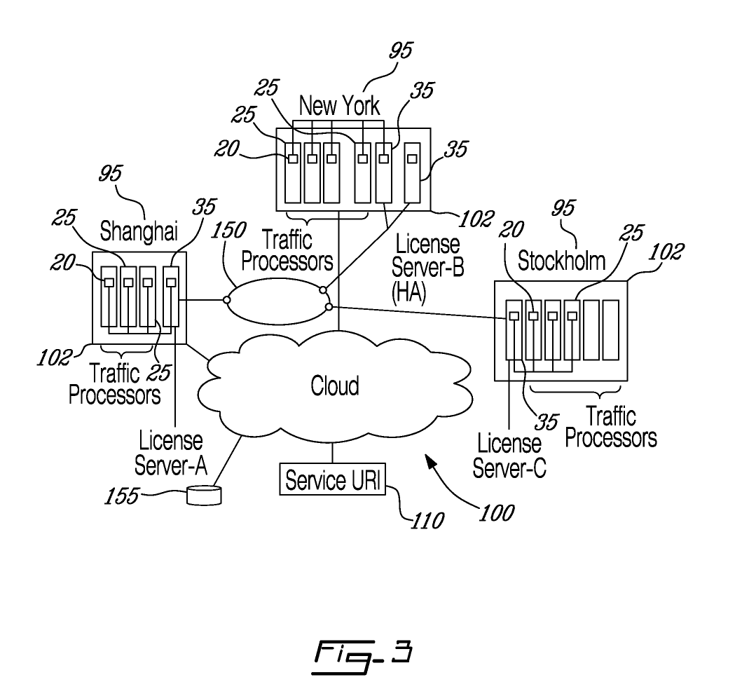

Turning to FIG. 3, the present invention provides a method and a license pool server instance 150 for redistributing license tokens for a service to license servers 35 across a cloud computing environment 100. Stated differently, the invention provides license control to handle the deployment of a distributed service in a cloud computing environment 100.

The license pool server instance 150 coordinates, distributes, allocates or redistributes license tokens managed by license server nodes 102 that are scattered across different physical location 95, such as different cities or countries and that are part of cloud computing environment 100.

Each physical site 95, such as for example Shanghai, New York or Stockholm has at least one license server 35 to handle the license token distribution inside a node 102. This license server 35 communicates with the license servers 35 located in other sites to form a license pool server instance 150 associated to the specified service. All the features under the service can be protected by the license pool server instance 150.

The license pool server instance 150 monitors all the nodes 102 across different sites for a specific service and applies the license control on the overall usage of the service. For instance, when one physical site 95 is shut down due to an accident, the license pool server instance 150 is able to re-allocate the license tokens to the remaining physical sites 95. When a new site is added, the license pool server instance 150 is also able to re-balanced or redistribute all the license tokens among all the involved sites.

Furthermore, the license pool server instance 150 may also makes a validation of the licensed features. When an application is deployed in the network and is ready for serving subscribers, clients or users, the service identity may be provided to the subscribers of the service. For instance, in the Internet Protocol (IP) Multimedia Subsystem (IMS), this service identity is called Public Service Identity (PSI) and has a Session Initiation Protocol (SIP) Uniform Resource Identifier (URI) format, such as server@domain.com. Each request from the subscribers carries this PSI in order to address the service. On the server side, the application can retrieve this service identity, PSI, from the received request and then pass it to the license pool server instance 150 when it makes the license request. The license pool server instance 150 is then able to verify how many license tokens are allocated for this PSI, which includes the domain name as shown in the example above. Then, the license pool server instance 150 decides to grant or reject the request accordingly. The service identity used for the license locking mechanism can be further encrypted when it is transferred to the license pool server instance 150.

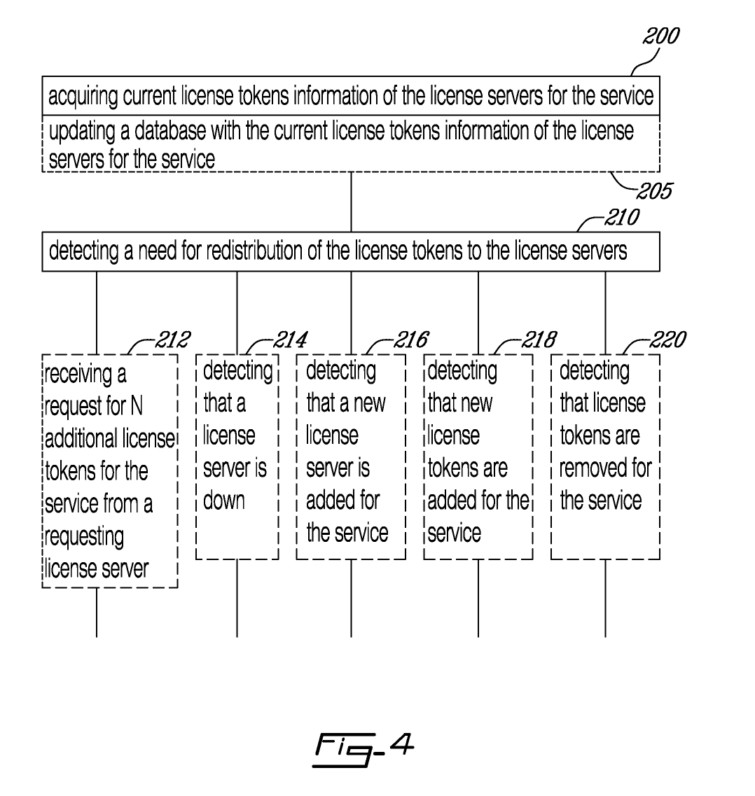

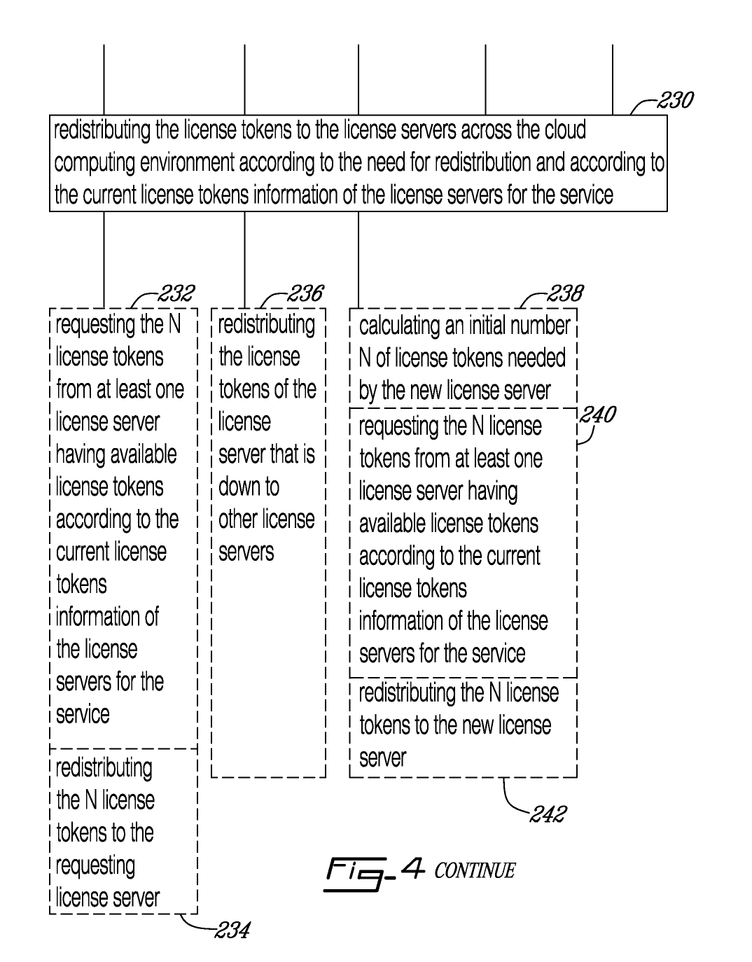

FIG. 4 is a flowchart of a method for redistributing license tokens for a service to license servers across a cloud computing environment. The method, which is executed by the license pool server instance, comprises the step 200 of acquiring current license tokens information of the license servers for the service. This step 200 can comprise a step 205 of updating a database or memory with the current license tokens information of the license servers for the service. Thus, the license key information may be populated in a memory such as a file system or a database accessible by the license pool server instance discussed previously, and which is part of cloud computing system or environment. The current license tokens information may take the form of a number of license tokens or any other form suitable for the needs of the invention, as it would be apparent to a person skilled in the art.

The method comprises the step 210 of detecting a need for redistribution of the license tokens to the license servers and the step 230 of redistributing the license tokens to the license servers across the cloud computing environment according to the need for redistribution and according to the current license tokens information of the license servers for the service. The current license tokens information of the license servers for the service may be stored in the memory or the database, as discussed above.

In the present invention, the license key and license token, or license management component, are not tied to the physical nodes as in the prior art. Instead, they are tied to the service identifier that is used by the end users, the clients or the applications, to identify the service. Therefore, when a client requests to use a service, with a service identifier, the license server responds to the client's request and generates a license key, if a license token is available. The license key is tied to the service identifier. The traditional capacity license token handling as discussed in the background section, or a variation thereof, can be used to generate the license key. If the traditional capacity license token handling as discussed in the background section is used, the license verification for the service request can be done either before or after processing the service request based, upon the chosen license techniques.

The service identifier for the service may be a service URI, as described previously or another suitable identifier. The method and license pool server instance are designed to be per service base. In other words, each service has its own license pool server instance. Furthermore, the license pool server instance is able to handle many clients or licensees, each of which being associated to a specific feature, or service. The license key for the features in the service is generated based upon the service identifier, e.g. service URI, instead of a traditional HW fingerprint, such as Media Access Controller (MAC) address, etc. The service is not locked to the hardware anymore. Now it is locked to the service identifier, which can be for example a service URI or a list of service Uniform Resource Locators (URLs). In order to protect the service identifier locking, in the license pool server instance, the encoding algorithm can be used. Examples of an encoding algorithm, or ciphers, comprise Advanced Encryption Standard (AES), Twofish, Blowfish, RC2 or RC4 where “RC” stands for “Ron's Code” or “Rivest Cipher”, or Data Encryption Standard (DES) or any other suitable encoding algorithm, as it would be apparent to a person skilled in the art.

The detecting step 210 of the method may take at least five different forms 212, 214, 216, 218 or 220 as explained below.

In step 212, the license pool server instance, which executes the method, receives a request for N additional license tokens for the service from a requesting license server. In this case, the redistributing step 230 comprises the step 232 of requesting the N license tokens from at least one license server having available license tokens according to the current license tokens information of the license servers for the service and the step 234 of redistributing the N license tokens to the requesting license server.

In step 214, the license pool server instance detects that a license server is down. In this case, the redistributing step 230 comprises the step 236 of redistributing the license tokens of the license server that is down to other license servers.

In step 216, the license pool server instance detects that a new license server is added for the service. In this case, the redistributing step 230 comprises the step 238 of calculating an initial number N of license tokens needed by the new license server, the step 240 of requesting the N license tokens from at least one license server having available license tokens according to the current license tokens information of the license servers for the service and the step 242 of redistributing the N license tokens to the new license server.

The detecting step 210 step of the method may also take the form of detecting that new license tokens are added for the service, step 218 or detecting that license tokens are removed for the service, step 220. In both these cases the redistributing step 230 applies.

It should be understood that the service may be a service executed in traffic processors. For example, with capacity licensing, the overall amount or rate of traffic for the service can be capped or otherwise constrained by a licensed transaction capacity. The licensed transaction capacity may be expressed as a limit on the allowed number of transactions-per-second (TPS), or expressed as some other constraint that limits the volume or rate of traffic permitted to be processed for the licensed service. Individual traffic processors thereafter process the service traffic according to a distribution of the licensed transaction capacity among the individual traffic processors within the traffic processor set. The allocation of licensed capacity to each traffic processor caps or otherwise sets that traffic processor's capacity for processing traffic for the licensed service.

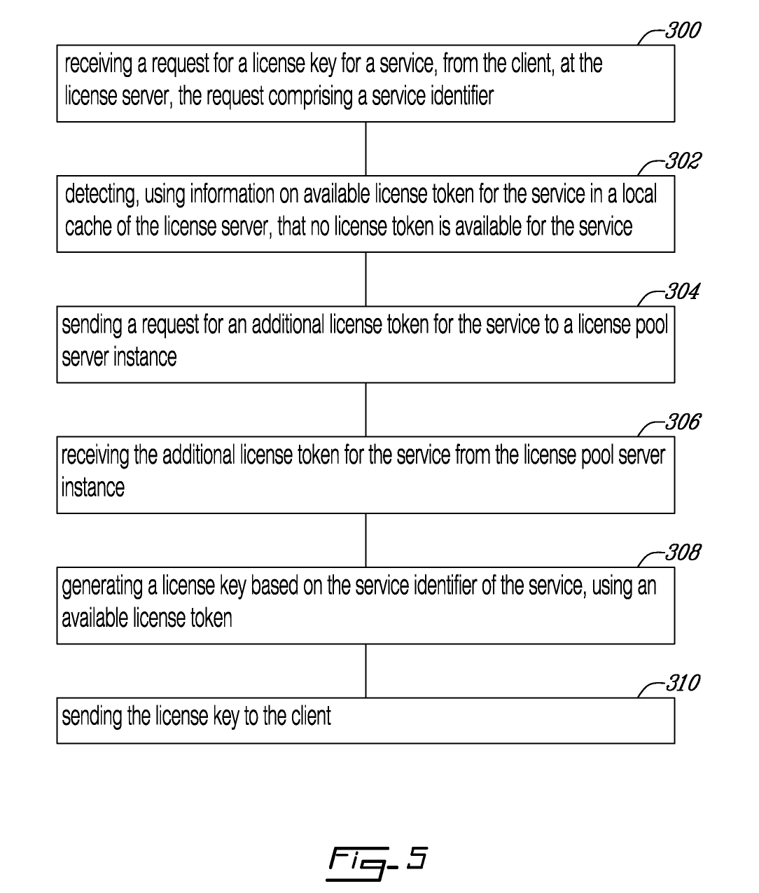

Referring now to FIG. 5, the steps of a method for distributing a license key for a service from a license server to a client in a cloud computing environment are depicted in the flow chart. The method comprises the step 300 of receiving a request for a license key for a service, from the client, at the license server, the request comprising a service identifier. The method also comprises the step 302 of detecting, using information on available license token for the service in a local cache of the license server, that no license token is available for the service. The method comprises the step 304 of sending a request for an additional license token for the service to a license pool server instance. The method comprises the step 306 of receiving the additional license token for the service from the license pool server instance. The method comprises the step 308 of generating a license key based on the service identifier of the service, using an available license token and the step 310 of sending the license key to the client.

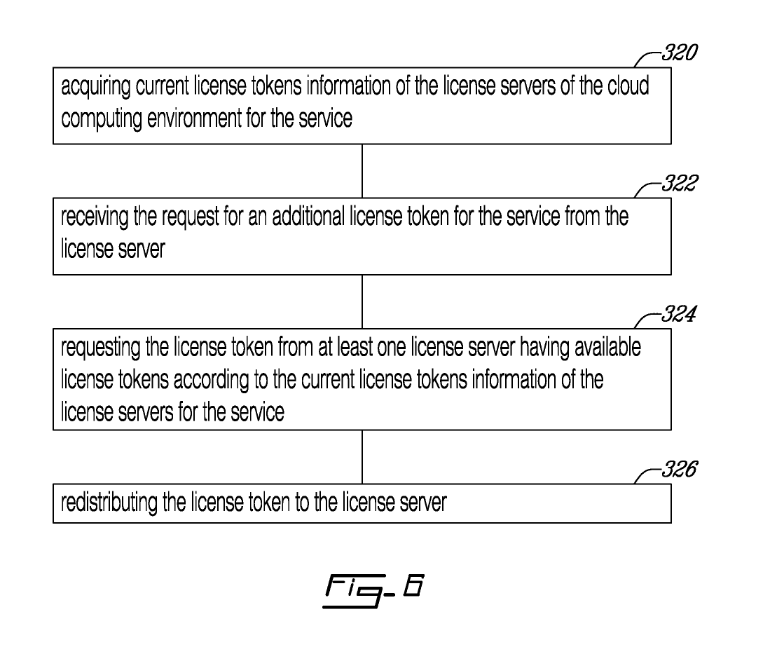

The license pool server instance of the method illustrated in FIG. 5 can execute the steps illustrated in FIG. 6. The license pool server instance, at step 320, acquires current license tokens information of the license servers of the cloud computing environment for the service. At step 322, the license pool server instance receives the request for an additional license token for the service from the license server. At step 324, the license pool server instance requests the license token from at least one license server having available license tokens according to the current license tokens information of the license servers for the service and at step 326, the license pool server instance redistributes the license token to the license server.

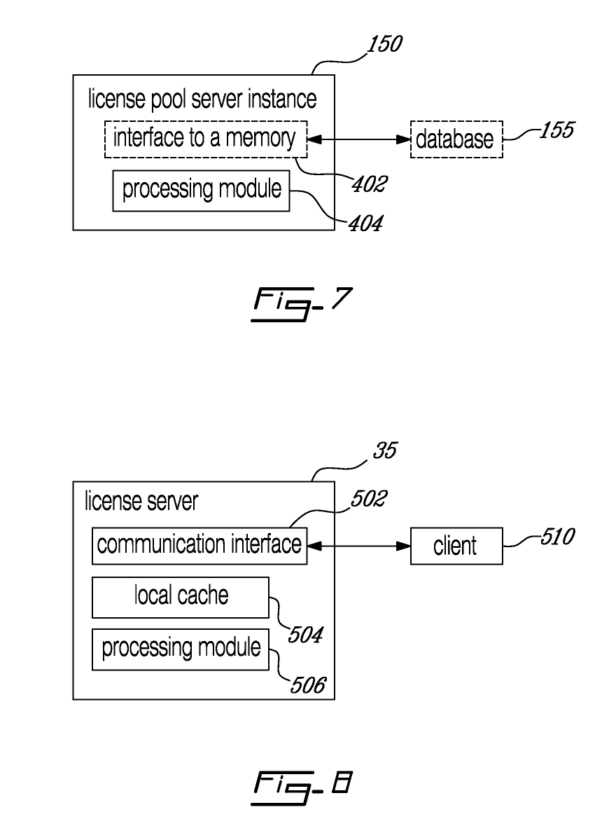

FIG. 7 illustrates a license pool server instance 150 for redistributing license tokens for a service to license servers across a cloud computing environment. The license pool server instance 150 comprises a processing module 404 for acquiring current license tokens information of the license servers for the service, for detecting a need for redistribution of the license tokens in the license servers and for redistributing license tokens to the license servers across the cloud computing environment according to the need for redistribution and according to the current license tokens information of the license servers for the service. An interface 402 to a database 155 may be used for updating a database with the current license tokens information of the license servers for the service. The license pool server instance may be implemented by a software application in communication with the license servers 35. The software application may be executed in a node of the cloud computing environment or may be distributed. The license pool server instance may run in a dedicated server or network node, for example.

FIG. 8 illustrates a license server 35 for distributing a license key for a service to a client 510 in a cloud computing environment. The license server 35 comprises a communication interface 502 for receiving a request for a license key for a service, from the client, the request comprising a service identifier. The license server 35 comprises a local cache 504 containing information on available license tokens for the service. The communication interface is further for sending a request for an additional license tokens for the service to a license pool server instance and for receiving the additional license token for the service from the license pool server instance. The license server 35 comprises a processing module 506 for generating a license key based on the service identifier of the service, using an available license token. The communication interface is further for sending the license key to the client.

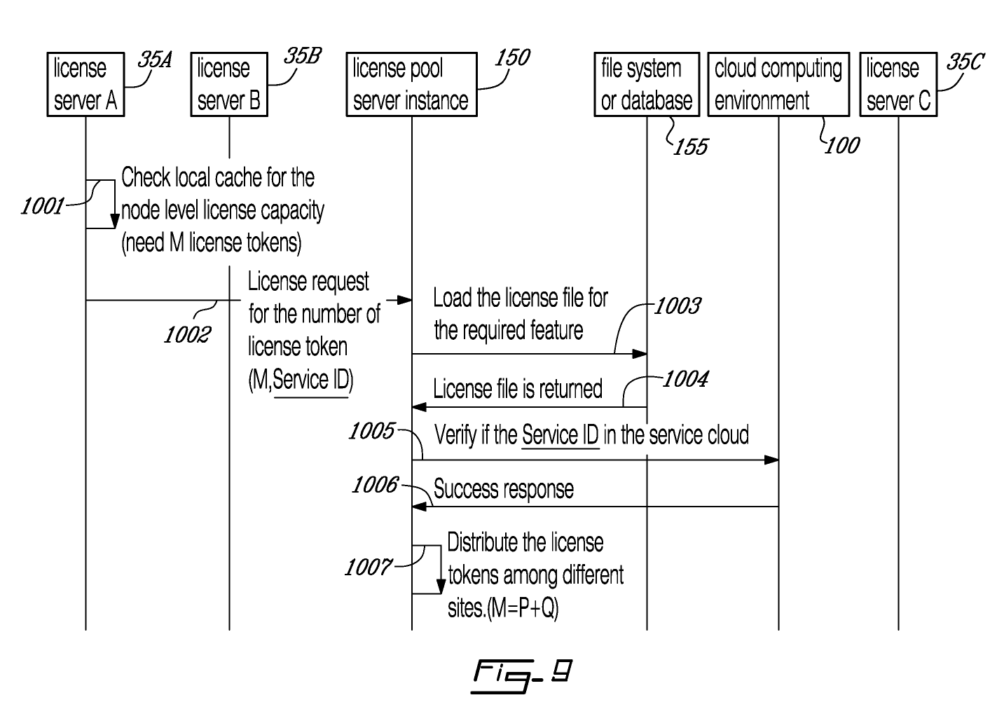

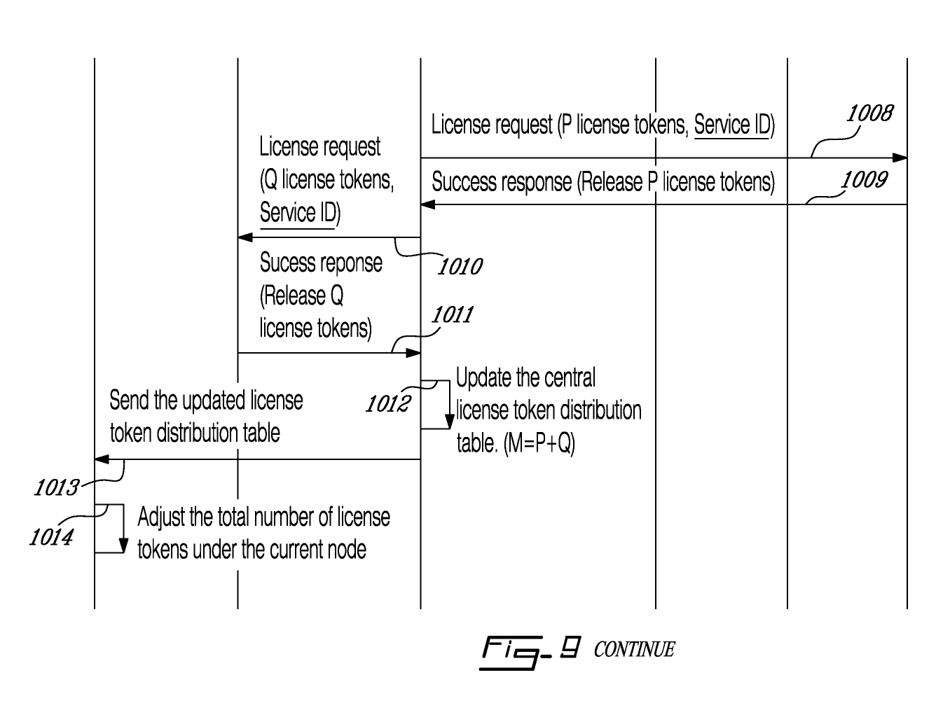

FIG. 9 shows a license token distribution flow according to an exemplary embodiment of the invention. The detailed steps describe one way for implementing the method and license pool server instance for redistributing license tokens for a service to license servers across a cloud computing environment. A person skilled in the art will readily understand that the invention is not limited to this particular embodiment.

At step 1001, the license server 35A checks its local cache for node level license capacity i.e. for the number of the cached license tokens. It is found that M license tokens are required. At step 1002, the license server 35A sends a license request to the license pool server instance 150 to reserve M license token for a specific service feature. Here the service identifier is included in the request. At step 1003, the license pool server instance 150 loads the corresponding license file from the file system or database 155.

This step is not required if the license key information in the license pool server instance 150 is valid. At step 1004, the file system 155 responds to the license pool server instance 150 with the required license key information.

At step 1005, the license pool server instance 150 verifies if the service identifier is in the service cloud 100 by invoking an Application Program Interface (API) offered by the cloud computing environment 100, such as Amazon EC2™ API, for example. At step 1006, the license pool server instance 150 receives the successful response on the verification of the service identifier. At step 1007, the license pool server instance 150 distributes the license tokens among different sites. For instance, the license server 35B releases Q license tokens; while the license server 35C releases P license tokens, therefore releasing a total of M=P+Q licenses, for example. At step 1008, the license pool server instance 150 sends a license request towards the license server 35C for P license tokens. At step 1009, the license server 35C agrees to release P license tokens by sending a “SUCCESS” response.

At step 1010, the license pool server instance 150 sends the license request towards the license server 35B for Q license tokens. At step 1011, the license server 35B agrees to release Q license tokens by sending a “SUCCESS” response. At step 1012, the license pool server instance 150 updates a central license token distribution table. At step 1013, the license pool server instance 150 sends the response with the number of tokens M required by the license server 35A. At step 1014, the license server 35A updates its local cache after receiving the M license tokens.

A mechanism to monitor the status of each license server may be implemented with heart-beat message communicated via the User Datagram Protocol (UDP) among all involved license servers. For example, in the embodiment described above, if the crash of a license server, for example license server 35B, is identified, the redistribution of its license tokens among the remaining alive license servers is triggered. When the license server 35B is back, the rebalance of license tokens it triggered. Three cases may be considered here, first license server 35B crashes before receiving the license request, second license server 35B crashes after receiving the license request and before sending the response and third, license server 35B crashes after sending the response. In those three cases, the license pool server instance 150 is notified as soon as the license server crashes and the re-distribution among the remaining license servers is trigged. If there is no license token available at this point, a warning or an alarm may be issued.

The invention has been described with reference to particular embodiments. However, it will be readily apparent to those skilled in the art that it is possible to embody the invention in specific forms other than those of the embodiments described above. The described embodiments are merely illustrative and should not be considered restrictive in any way. The scope of the invention is given by the appended claims, rather than the preceding description, and all variations and equivalents that fall within the range of the claims are intended to be embraced therein.

1. A method for redistributing license tokens for a service to license servers across a cloud computing environment, comprising the steps of:
a) acquiring current license tokens information of the license servers for the service;
b) detecting a need for redistribution of the license tokens to the license servers; and
c) redistributing the license tokens to the license servers across the cloud computing environment according to the need for redistribution and according to the current license tokens information of the license servers for the service.

2. The method of claim 1 wherein the detecting step comprises receiving a request for N additional license tokens for the service from a requesting license server.

3. The method of claim 2 wherein the redistributing step comprises:
d) requesting the N license tokens from at least one license server having available license tokens according to the current license tokens information of the license servers for the service;
e) redistributing the N license tokens to the requesting license server.

4. The method of claim 1 wherein the detecting step comprises detecting that a license server is down.

5. The method of claim 4 wherein the redistributing step comprises:
d) redistributing the license tokens of the license server that is down to other license servers.

6. The method of claim 1, wherein the detecting step comprises detecting that a new license server is added for the service.

7. The method of claim 6 wherein the redistributing step comprises:
d) calculating an initial number N of license tokens needed by the new license server;
e) requesting the N license tokens from at least one license server having available license tokens according to the current license tokens information of the license servers for the service;
f) redistributing the N license tokens to the new license server.

8. The method of claim 1, wherein the detecting step comprises detecting that new license tokens are added for the service.

9. The method of claim 1, wherein the detecting step comprises detecting that license tokens are removed for the service.

10. The method of claim 1, wherein the step of acquiring comprises updating a database with the current license tokens information of the license servers for the service.

11. The method of claim 1, wherein the service is executed in traffic processors.

12. The method of claim 1, wherein the current license tokens information of the license servers for the service comprises a number of license tokens of the license servers for the service.

13. A method for distributing a license key for a service from a license server to a client in a cloud computing environment, comprising the steps of:
i) receiving a request for a license key for a service, from the client, at the license server, the request comprising a service identifier;
ii) detecting, using information on available license token for the service in a local cache of the license server, that no license token is available for the service;
iii) sending a request for an additional license token for the service to a license pool server instance;
iv) receiving the additional license token for the service from the license pool server instance;
iv) generating a license key based on the service identifier of the service, using an available license token; and
v) sending the license key to the client.

14. The method of claim 13, wherein the license pool server instance executes the steps of:
a) acquiring current license tokens information of the license servers of the cloud computing environment for the service;
b) receiving the request for an additional license token for the service from the license server;
c) requesting the license token from at least one license server having available license tokens according to the current license tokens information of the license servers for the service; and
d) redistributing the license token to the license server.

15. The method of claim 13, wherein the service identifier is a service Uniform Resource Identifier (URI).

16. A license pool server instance for redistributing license tokens for a service to license servers across a cloud computing environment, the license pool server instance comprising:
a processing module for acquiring current license tokens information of the license servers for the service, for detecting a need for redistribution of the license tokens in the license servers and for redistributing license tokens to the license servers across the cloud computing environment according to the need for redistribution and according to the current license tokens information of the license servers for the service.

17. The method of claim 16, wherein an interface to a database is used for updating a database with the current license tokens information of the license servers for the service.

18. The method of claim 16, wherein the service is executed in traffic processors.

19. A license server for distributing a license key for a service to a client in a cloud computing environment, comprising:
a communication interface for receiving a request for a license key for a service, from the client, the request comprising a service identifier;
a local cache containing information on available license tokens for the service; and
the communication interface further being for sending a request for an additional license tokens for the service to a license pool server instance and for receiving the additional license token for the service from the license pool server instance;
a processing module for generating a license key based on the service identifier of the service, using an available license token;
the communication interface further being for sending the license key to the client.
